(19) United States
(12) Patent Application Publication
(10) Pub. No.: US 2012/0237285 A1
(43) Pub. Date: Sep. 20, 2012

(54) FULL BREAKOUT ARM FOR AUTOMATIC DOORS

(76) Inventor: Jean-Marc Tognet, Allevard Les Bains (FR)

(21) Appl. No.: 13/022,297

(22) Filed: Mar. 14, 2011

(51) Int. Cl. F16C 11/06

(52) U.S. Cl. 403/122

(57) ABSTRACT

A full breakout arm (1) having a sliding arm (4) that is attached to a door (2) along an upper edge (5) of the door. The sliding arm has a first end (6) fixedly and pivotally attached to a hinged side of the door. A release mechanism (9) is mounted to the opposite side of the door. A channel (13) located along the sliding arm is slidably and pivotally attached to a first end (15) of a rotating arm (14) via a pivot point (16) that slides within the channel. A second end (17) of the rotating arm is attached to a motor (3). When excess pressure is placed on the door, the release mechanism disengages from the second end of the sliding arm and the first end of the sliding arm remains fixedly and pivotally attached to the door while the pivot point of the rotating arm slides back and forth within the channel of the sliding arm.

### BACKGROUND OF THE INVENTION

This invention relates to the automatic doors, more particularly, a full breakout arm having a sliding arm and breakaway mechanism that partially detaches the door from the motor if excess pressure is applied to the door and/or in the event of an emergency.

Automatic doors are commonly used in facilities, such as super markets, malls, hospitals, etc., to provide easy access for disabled individuals and individuals pushing shopping carts, baby carriages and so forth. Swinging automatic doors are opened and closed by a motor that is activated by a motion sensor or button. Once the motor is activated, it engages the door and does not allow for manual opening or closing of the door. A common problem caused by the engagement of the motor with the door is damage to the motor and/or the door caused by individuals attempting to manually push the door open faster than the speed at which the motor is operating. For example, an individual may hit the door with a shopping cart not realizing that the motor is engaged with the door. The impact of the shopping cart hitting the door will not push the door open any faster. Instead the impact from the shopping cart will at times cause damage to the frame of the door, break glass in the door and/or cause damage to the motor. An additional problem caused by the engagement of the motor with the door occurs during power outages. If the motor loses power while engaged to the door than the door will be locked in place.

Therefore a need exists for a mechanism that will allow the door to be easily released from the motor when excess pressure is applied to the door, thereby preventing damage to the door and/or the motor.

The relevant prior art includes the following patent references:

| Pat./Ser. No. | Inventor | Issue/Publication Date |
|---|---|---|
| 7,418,800 | Sellman | Sep. 02, 2008 |
| 7,373,756 | Okulov | May 20, 2008 |
| 7,316,096 | Houser et al. | Jan. 08, 2008 |
| 7,310,911 | Sellman | Dec. 25, 2007 |
| 7,254,918 | Fronz et al. | Aug. 14, 2007 |
| 6,634,140 | Sellman | Oct. 21, 2003 |
| 6,283,189 | Liebscher | Sep. 04, 2001 |
| 5,988,711 | Toma | Nov. 23, 1999 |
| 5,399,851 | Strand | Mar. 21, 1995 |
| 5,018,304 | Longoria | May 28, 1991 |
| 4,289,995 | Sorber et al. | Sep. 15, 1981 |
| 3,777,620 | Schultheiss | Dec. 11, 1973 |
| 3,136,538 | Dimmitt et al. | Jun. 09, 1964 |
| 2,591,693 | Gatesy | Apr. 08, 1952 |

### SUMMARY OF THE INVENTION

The primary object of the present invention is to provide a full breakout arm for automatic doors that will allow the door to be easily released from the motor when excess pressure is applied to the door.

An even further object of the present invention is to provide a full breakout arm for automatic doors that will prevent damage to the automatic door when excess pressure is applied to the door.

Another object of the present invention is to provide a full breakout arm for automatic doors that will prevent damage to the motor when excess pressure is applied to the door.

An even further object of the present invention is to provide a full breakout arm for automatic doors that will allow the door to be opened in emergency situations.

The present invention fulfills the above and other objects by providing a full breakout device having a sliding arm with a first end and a second end. The sliding arm is preferably attached to a swinging door along an upper edge of the swinging door. The first end of the sliding arm is fixedly and pivotally attached to a hinged side of the door via a clevis fastener. A release mechanism is mounted to the opposite side of the door. The release mechanism engages the second end of the sliding arm via a pressure ball that engages an aperture located on the second end of the sliding arm. When excess pressure is applied to the door the pressure ball automatically pushes downward into the release mechanism, thereby freeing the second end of the sliding arm from the release mechanism and the door. The tension of the pressure ball may be adjusted via a screw located on a lower surface of the release mechanism. A channel is located along the upper surface of the sliding arm. The channel is slidably and pivotally attached to a first end of the rotating arm. A second end of the rotating arm is attached to a motor that rotates the rotating arm in order to open and shut the door. The motor is preferably mounted to a wall above the door. When the release mechanism is disengaged from the second end of the sliding arm, the first end of the sliding arm remains fixedly and pivotally attached to the door while the rotating arm slides back and forth within the channel of the sliding arm. This device prevents damage to the door while allowing for easy re-attachment of the second end of the sliding arm back to the door and to the release mechanism.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a full breakout arm of the present invention mounted on a door;

FIG. 2 is a top perspective view of a full breakout arm of the present invention;

FIG. 3 is a partial cutaway side view of a release mechanism of the present invention;

FIG. 4 is a bottom view of a release mechanism of the present invention;

FIG. 5 is a cross-section view along line 5-5 of FIG. 2 showing a sliding arm and channel;

FIG. 6 is a top view of a full breakout arm of the present invention in which a second end of a sliding arm has been disengaged from a door that has been swung inward; and

FIG. 7 is a top view of a full breakout arm of the present invention in which a second end of a sliding arm has been disengaged from a door that has been swung outward.

### DESCRIPTION OF THE PREFERRED EMBODIMENTS

For purposes of describing the preferred embodiment, the terminology used in reference to the numbered components in the drawings is as follows:

```
  1. full breakout arm
  2. door
  3. motor
  4. sliding arm
  5. upper edge of door
  6. first end of sliding arm
  7. attachment means
  8. clevis fastener
  9. release mechanism
10. second end of sliding door
11. pressure ball
12. aperture
13. channel
14. rotating arm
15. first end of rotating arm
16. pivot point
17. second end of rotating arm
18. wall
19. base
20. adjustment means
21. screw
22. engagement means
23. spring
```

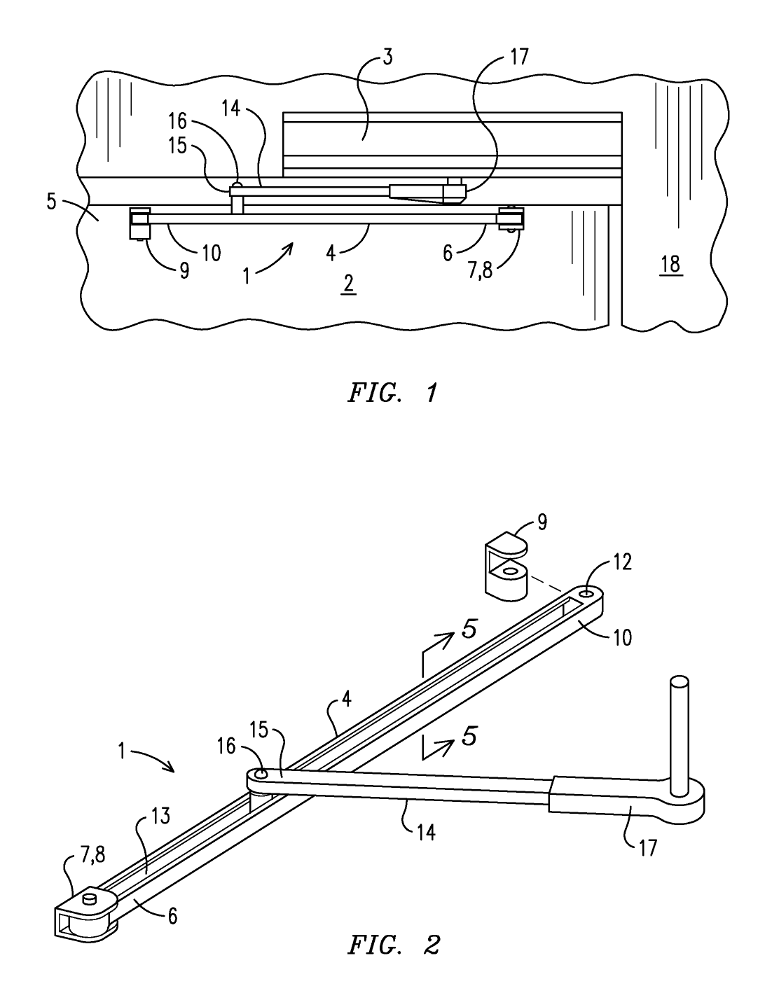

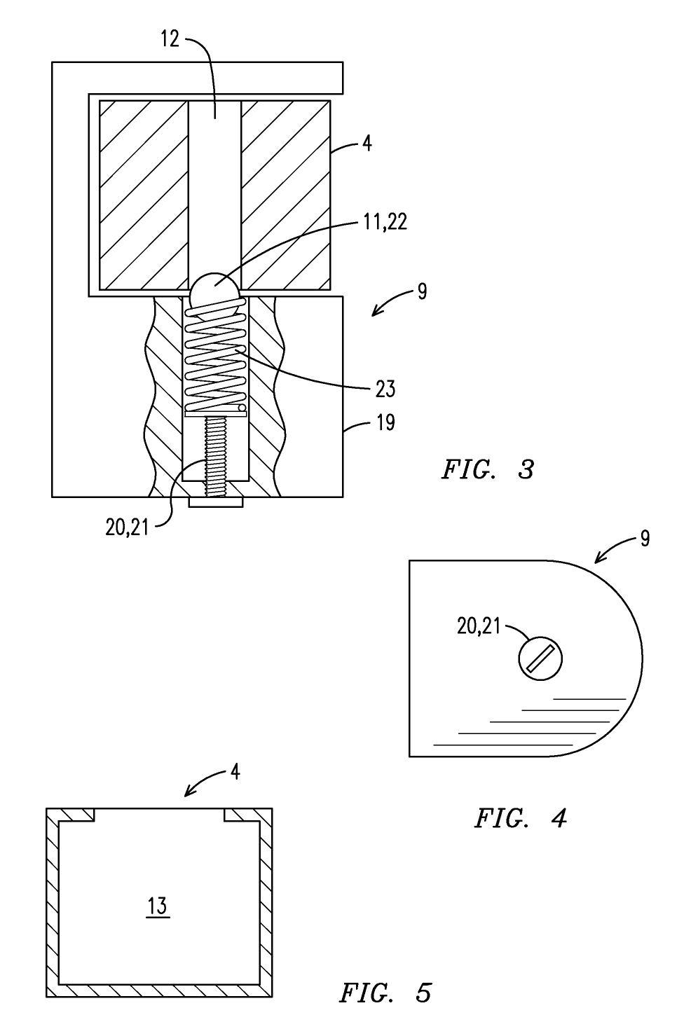

With reference to FIGS. 1 and 2, a front view of a full breakout arm 1 of the present invention mounted on a door 2 and attached to a motor 3 and a top perspective view of a full breakout arm of the present invention, respectively, are shown. The full breakout arm 1 comprises a sliding arm 4 that is attached to the door 2 along an upper edge 5 of the door 2. The sliding arm 4 has a first end 6 fixedly and pivotally attached to a hinged side of the door 2 via an attachment means 7, such as a clevis fastener 8. A release mechanism 9 is mounted to the opposite side of the door 2. The release mechanism 9 engages a second end 10 of the sliding arm 4 via an engagement means 22, such as a pressure ball 11, as shown in FIGS. 3 and 4, that engages an aperture 12 located on the second end 10 of the sliding arm 4. A channel 13 is located along an upper surface of the sliding arm 4. The channel 13 is slidably attached and pivotally attached to a first end 15 of a rotating arm 14 via a pivot point 16 that slides within the channel 13. A second end 17 of the rotating arm 14 is attached to the motor 3 that rotates the rotating arm 14 in order to open and shut the door 1. The motor 3 is preferably mounted to a wall 18 above the door 2.

With reference to FIGS. 3 and 4, a partial cutaway side view and a bottom view, respectively, of a release mechanism 9 of the present invention are shown. The release mechanism 9 is substantially U-shaped to engage a second end 10 of a sliding arm 4, as shown previously in FIGS. 1 and 2, via an engagement means 22, such as a pressure ball 11 that engages an aperture 12 located on the second end 10 of the sliding arm 4. When excess pressure is applied to a door 2 the pressure ball 11 automatically pushes downward into a base 19 of the release mechanism 9, thereby freeing the second end 10 of the sliding arm 4 from the release mechanism 9 and the door. The tension of spring 23 that applies pressure on the pressure ball 11 may be adjusted via an adjustment means 20, such as a screw 21, located on a lower surface of the release mechanism 9.

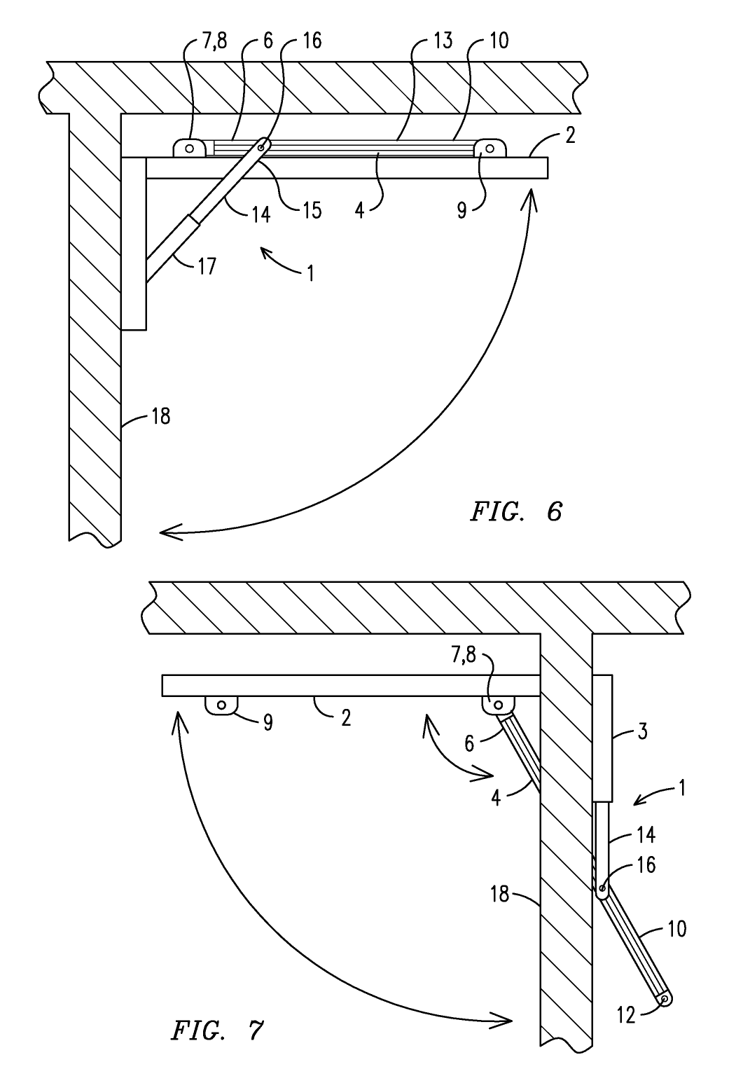

With reference to FIG. 5, a cross-section view along line 5-5 of FIG. 2 showing a sliding arm 4 and channel 13. The channel 13 is slidably attached and pivotally attached to a first end 15 of a rotating arm 14 via a pivot point 16 that slides within the channel 13, as illustrated further in FIGS. 6 and 7.

With reference to FIG. 6, a top view of a full breakout arm 1 of the present invention in which a second end 10 of a sliding arm 4 has been disengaged from a door 2 that has been swung inward. When the pressure ball 11, as shown in FIG. 3, of the release mechanism 9 presses down and disengages from the aperture 12 located on the second end 10 of the sliding arm 4, the first end 6 of the sliding arm 4 remains fixedly and pivotally attached to the door 2 while the while pivot point 16 of the rotating arm 14 slides back and forth within the channel 13 of the sliding arm 4. This prevents damage to the door 2 while allowing for easy re-attachment of the second end 10 of the sliding arm 4 back to the door 2 and to the release mechanism 9.

Finally with reference to FIG. 7 a top view of a full breakout arm 1 of the present invention in which a second end 10 of a sliding arm 4 has been disengaged from a door 2 that has been swung outward. When the pressure ball 11, as shown in FIG. 3, of the release mechanism 9 presses down and disengages from the aperture 12 located on the second end 10 of the sliding arm 4, the first end 6 of the sliding arm 4 remains fixedly and pivotally attached to the door 2 while pivot point 16 of the rotating arm 14 slides back and forth within the channel 13 of the sliding arm 4. This prevents damage to the door 2 while allowing for easy re-attachment of the second end 10 of the sliding arm 4 back to the door 2 and to the release mechanism 9. As shown here, the door 2 has been swung outward meaning the rotating arm 14 and the pivot point 16 have come into contact with the wall 18 and the top of the door jam, thereby preventing further outward rotation and causing the second end 10 of the sliding arm 4 to disengage from the release mechanism 9.

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is not considered to be limited to what is shown and described in the specification and drawings.

Having thus described my invention, I claim:

1. A full breakout arm for attaching a motor to a swinging automatic door comprising:
a sliding arm having a first end, a second end and a channel located along a surface of the sliding arm;
a rotating arm having a first end and a second end, said first end pivotally attached to the sliding arm via a pivot point that slides along the channel of the sliding arm;
an attachment means pivotally attached to the first end of the sliding arm for attaching the first end of the sliding arm to a door; and
a release mechanism removably attached to the second end of the sliding arm.

2. The full breakout arm of claim 1 wherein:
said release mechanism is substantially U-shaped and has a an engagement means for engaging a second end of the sliding arm.

3. The full breakout arm of claim 2 wherein:
said engagement means comprises a pressure ball for engaging an aperture located on the second end of the sliding arm.

4. The full breakout arm of claim 2 wherein:
said release mechanism further comprises an adjustment means for adjusting the tension of the engagement means.

5. The full breakout arm of claim 4 wherein:
said adjustment means for adjusting the tension of the pressure ball is a screw.

6. The full breakout arm of claim 1 wherein:
said attachment means pivotally attached to the first end of the sliding arm is a clevis fastener.

7. A full breakout arm for attaching a motor to a swinging automatic door comprising:
a sliding arm having a first end, a second end and a channel located along a surface of the sliding arm;
a rotating arm having a first end and a second end, said first end pivotally attached to the sliding arm via a pivot point that slides along the channel of the sliding arm;
an attachment means pivotally attached to the first end of the sliding arm for attaching the first end of the sliding arm to a door; and
a release mechanism substantially U-shaped release mechanism having an engagement means for engaging a second end of the sliding arm.

8. The full breakout arm of claim 7 wherein:
said engagement means comprises a pressure ball for engaging an aperture located on the second end of the sliding arm.

9. The full breakout arm of claim 7 wherein:
said release mechanism further comprises an adjustment means for adjusting the tension of the engagement means.

10. The full breakout arm of claim 9 wherein:
said adjustment means for adjusting the tension of the pressure ball is a screw.

11. The full breakout arm of claim 7 wherein:
said attachment means pivotally attached to the first end of the sliding arm is a clevis fastener.

12. A full breakout arm for attaching a motor to a swinging automatic door comprising:
a sliding arm having a first end, a second end and a channel located along a surface of the sliding arm;
a rotating arm having a first end and a second end, said first end pivotally attached to the sliding arm via a pivot point that slides along the channel of the sliding arm;
an attachment means pivotally attached to the first end of the sliding arm for attaching the first end of the sliding arm to a door; and
a release mechanism substantially U-shaped release mechanism having a pressure ball for engaging an aperture located on the second end of the sliding arm.

13. The full breakout arm of claim 12 wherein:
said release mechanism further comprises an adjustment means for adjusting the tension of the engagement means.

14. The full breakout arm of claim 13 wherein:
said adjustment means for adjusting the tension of the pressure ball is a screw.

15. The full breakout arm of claim 12 wherein:
said attachment means pivotally attached to the first end of the sliding arm is a clevis fastener.
